(19) United States
(12) Patent Application Publication
(10) Pub. No.: US 2019/0217951 A1
(43) Pub. Date: Jul. 18, 2019

(54) HOVERCRAFT

(71) Applicant: Byron J. Willner, Hot Springs, VA (US)

(72) Inventor: Byron J. Willner, Hot Springs, VA (US)

(21) Appl. No.: 15/870,216

(22) Filed: Jan. 12, 2018

(51) Int. Cl. B64C 39/00; B64C 15/14; B64D 27/02

(52) U.S. Cl. CPC B64C 39/001; B64D 27/02; B64C 15/14

(57) ABSTRACT

The present invention is directed to a saucer type hovercraft having at least a pair of selectively counter-rotating lift and stabilization rings. The rings are held in place by correspondingly shaped circular bearing tracks and are powered by thrusters and electromagnets such that a central shaft is not needed. A wireless control system is used to control both speed and direction of rotation of the wings.

### BACKGROUND OF THE INVENTION

### Field of the Invention

The present invention relates to aircraft. More particularly, the invention relates to an improved hovercraft having stable aerodynamic qualities.

### Description of the Prior Art

U.S. Pat. No. 6,450,446 issued to Holben discloses a typical circular wing aircraft. A pair of shaft driven circular wings are provided motive power from e.g., an internal combustion motor. The aircraft has an elongated fuselage and essentially functions as a helicopter. By contrast, the present invention contemplates a saucer type hovercraft having inner and outer rings which are driven by thrusters and electromagnets exclusively.

U.S. Pat. No. 6,398,159 issued to Di Stefano discloses a saucer type hovercraft having multiple shaft driven wings. The present invention contemplates a hovercraft having no mechanical linkage to a rotating source of motive power, with wireless control provided to control rotation of both rings.

The present invention is directed to a saucer type hovercraft having at least a pair of selectively counter-rotating lift and stabilization rings. The outer ring is held in place by bearing assemblies and is powered by thrusters or electromagnets such that a central shaft is not needed. A wireless control system is used to control both speed and direction of rotation of the rings.

### SUMMARY OF THE INVENTION

It is a major object of the invention to provide an improved saucer type hovercraft.

It is another object of the invention to provide an improved saucer type hovercraft having at least a pair of counter-rotating circular lift and stabilization rings.

It is another object of the invention to provide an improved saucer type hovercraft where the outer ring is provided power from electromagnets and/or thrusters.

It is another object of the invention to provide an improved saucer type hovercraft having a wireless control system.

### BRIEF DESCRIPTION OF THE DRAWINGS

Various other objects, features, and attendant advantages of the present invention will become more fully appreciated as the same becomes better understood when considered with the accompanying drawings, in which like reference characters designate the same or similar parts throughout the several views, and wherein:

FIG. 1 is an elevational view of the hovercraft of the invention.

FIG. 2 shows a top view of the hovercraft of the invention.

FIG. 3 is a top view, partly in section, of the hovercraft Meg-Lev of the invention.

FIG. 4 is a top view, partly in section, of the hovercraft rotational thrusters of the invention.

FIG. 5 shows a top view of the hovercraft of the invention detailing the positioning of the roller bearings.

FIG. 6 is a top view, partly in section, of the hovercraft roller bearing assembly of the invention.

FIG. 7 shows an elevational detail of the roller bearing assembly of the hovercraft Meg-Lev of the invention.

FIG. 8 shows an elevational detail of the roller bearing assembly of the hovercraft rotational thrusters of the invention.

FIG. 9 is an elevational view of the hovercraft outer ring rotational thrusters of the invention.

FIG. 10 is an elevational view of the hovercraft middle ring articulating thrusters of the invention.

FIG. 11 is a top view, partly in section, of the hovercraft control section of the invention.

### DETAILED DESCRIPTION OF THE PREFERRED EMBODIMENTS

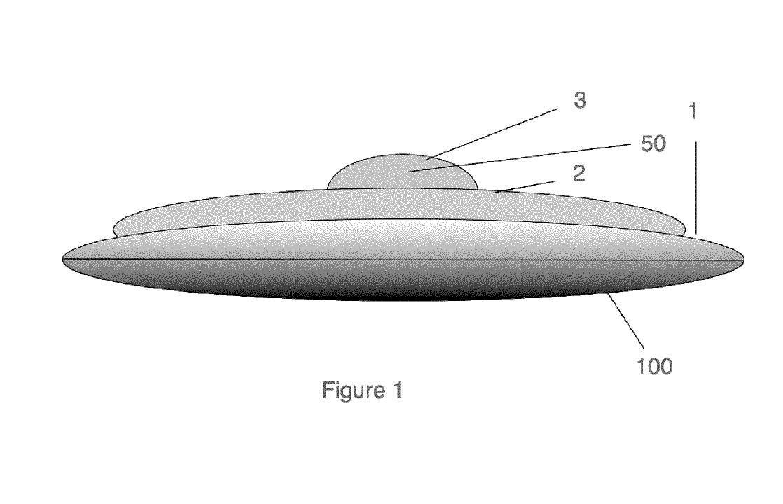

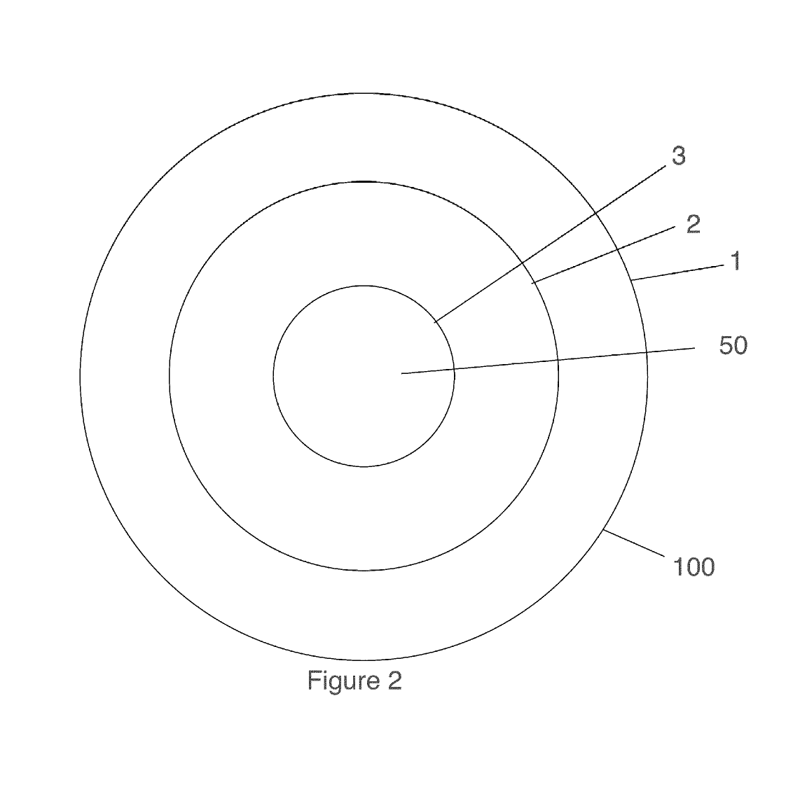

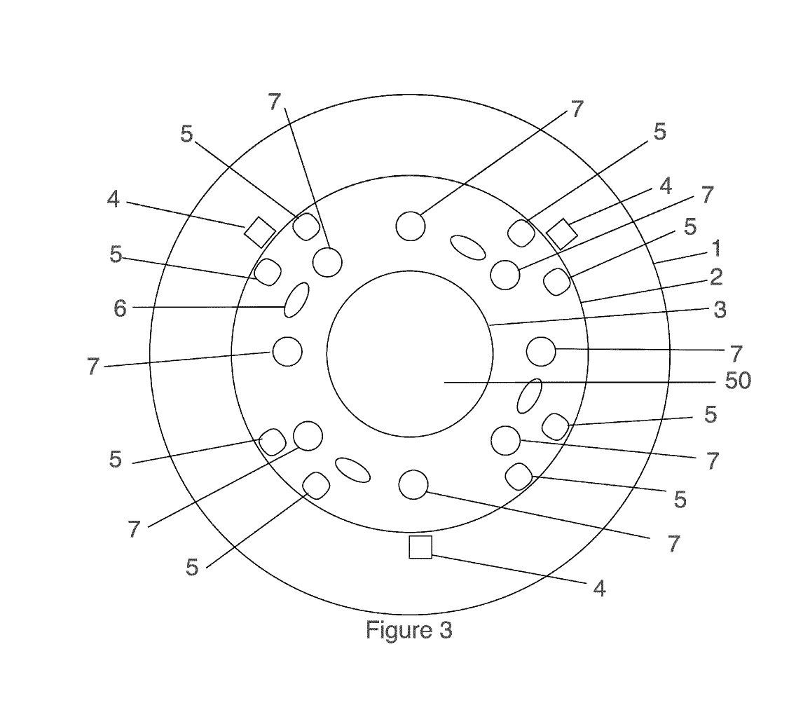

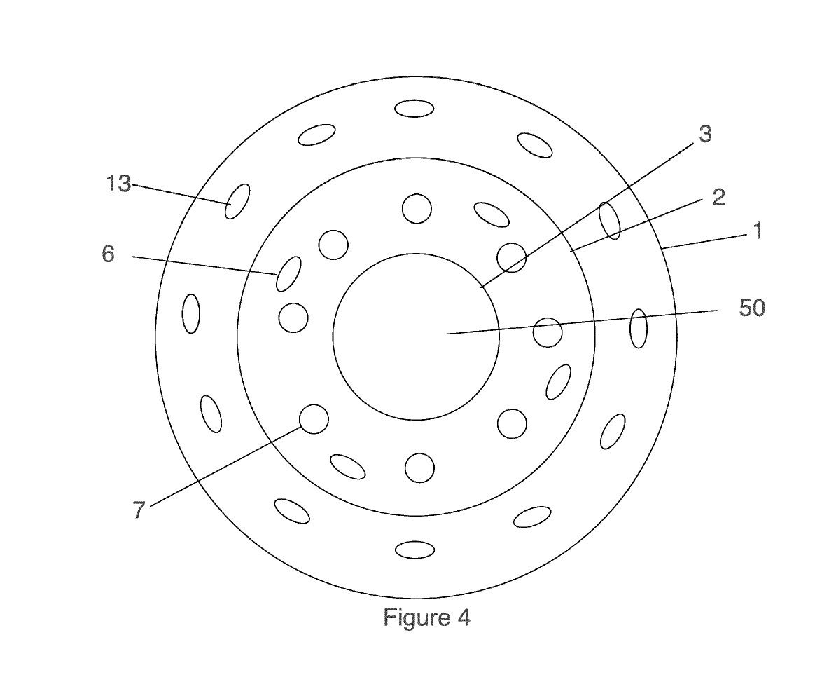

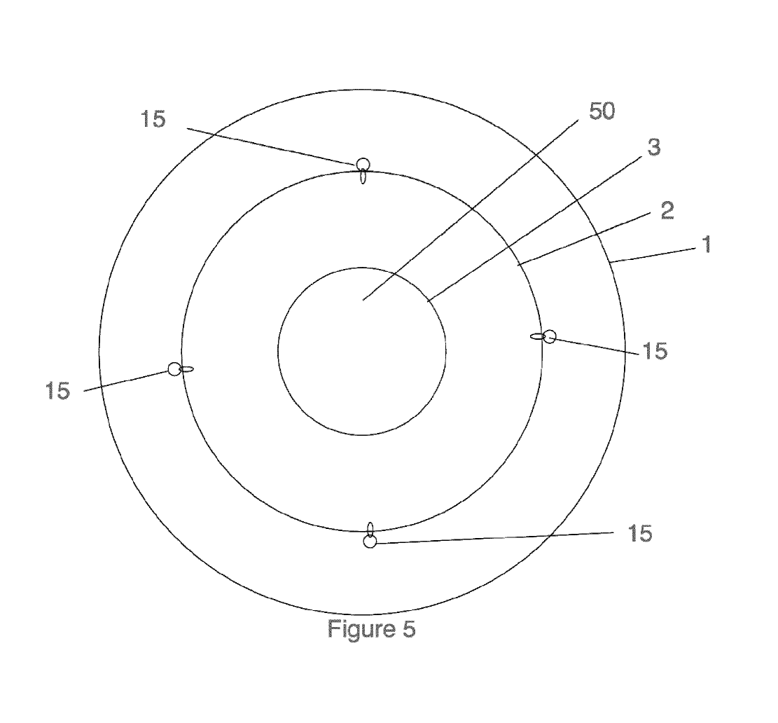

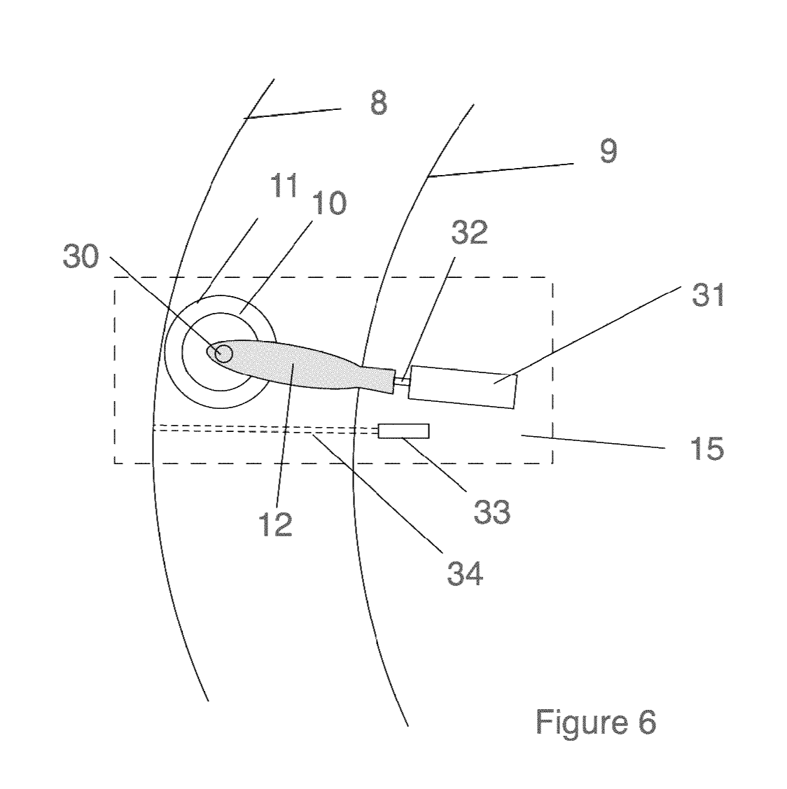

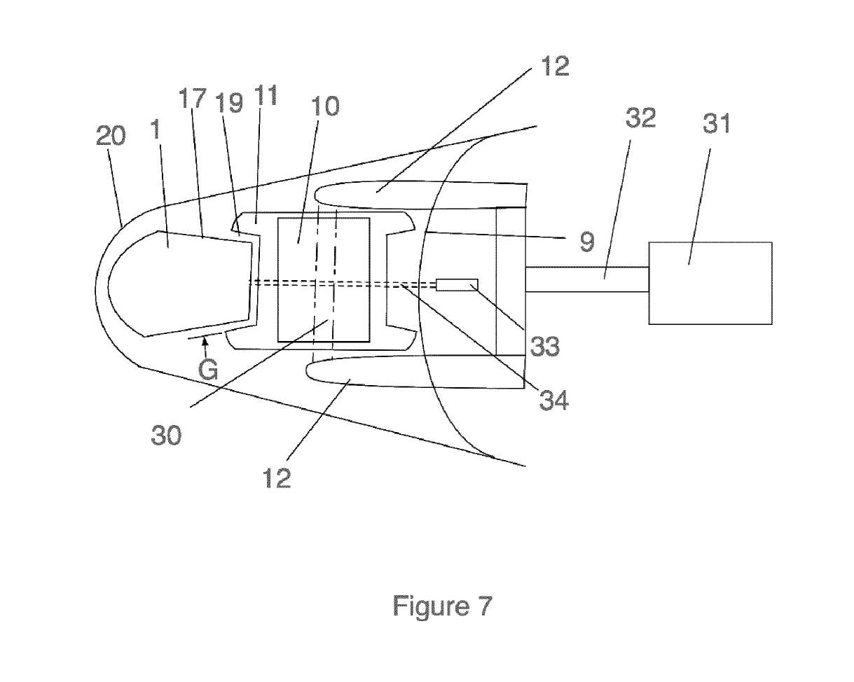

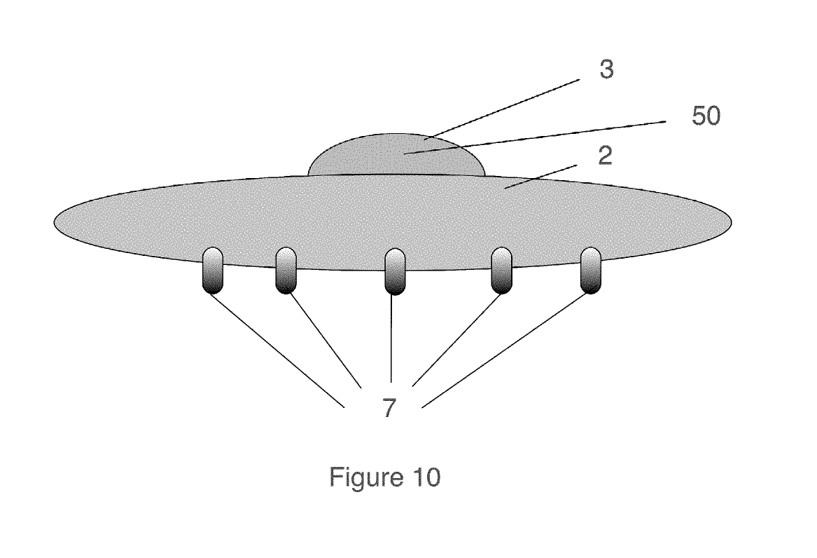

Referring now to FIGS. 1-11, the hovercraft of the invention is illustrated. The hovercraft 100 has a substantially disc shaped housing which forms a “saucer” type shape. The hovercraft 100 can be maneuvered in three dimensions using controls to manipulate the hovercraft 100. The hovercraft 100 includes a segmented outer housing 20 having an open underside which contains, in rotatable fashion, a pair of rings which provide the lift, acceleration, and aerodynamic stability required to manipulate the craft 100. The outer ring 1 is rotatably attached within the hovercraft 100 by a series of circumferentially spaced bearing assemblies 15, supplemented by a magnetic suspension arrangement as described below. The outer ring 1 has an inwardly projecting annular engagement portion 17 the edge of which is sized for engagement within grooves 19 of bearing wheels 10. Bearing wheels 10 depend from bearing assemblies 15, the wheels attached to the bearing assemblies 15 in rotating fashion. Each of the bearing assemblies 15 is attached to a respective edge portion of inner ring 2. The bearing assemblies 15 may be radially adjusted (i.e., the bearing wheels 10 are extended and retracted) in continuously reciprocating manner to ensure that the gap G between ring 17 and groove 19 remains within around 10 millimeters to reduce the possibility of excessive wobbling of the outer ring at high rotational speeds. Each of the bearing wheels 10 are laterally displaced, i.e., reciprocated by drive motor 31 which is attached to ring 2, the drive motor 31 serving to selectively reciprocate shaft 32 which is connected to bearing bracket 12 which rotatably supports bearing wheels 10. The gap G is sensed by a laser 33 control assembly which sends a control signal to the motor 31, the control signal varying with the spacing gap G so that a control loop is formed.

The outer ring 1 provides for a gyroscopic effect to stabilize the flight of the craft 100. The outer ring 1 is suspended for free rotation by the bearing assemblies 15 and by a series of permanent magnets 4 which interact with electromagnets 5 contained within the inner ring 2. The electromagnets 5 are activated sequentially by an electronic controller 51 so as to provide a magnetic levitation field which can be used to both lift (if uncovered) and rotate outer ring. The outer ring 1 is preferably hollow and capable of storing a quantity of fuel for powering thrusters as will be explained in more detail later. Also, the weight of the fuel (or optionally an inert liquid as discussed below) helps to increase the mass of the ring 1 which in turn increases the gyroscopic effect of the ring. Thus, outer ring 1 functions to provide a gyroscopic effect as well as some lift for the craft 100.

Optionally, the outer ring 1 may contain a series (at least three) of rotational thrusters 13 circumferentially spaced and angled downwardly in a manner apparent to one of skill in the art. Electrical control of the thrusters 13 is provided either wired or wirelessly from central control system 51. The speed of rotation of the ring 1 in this configuration can be controlled by varying thruster 13 output or by the use of deflection plates as is known in the arts. Fuel for the thrusters is contained within the ring 1.

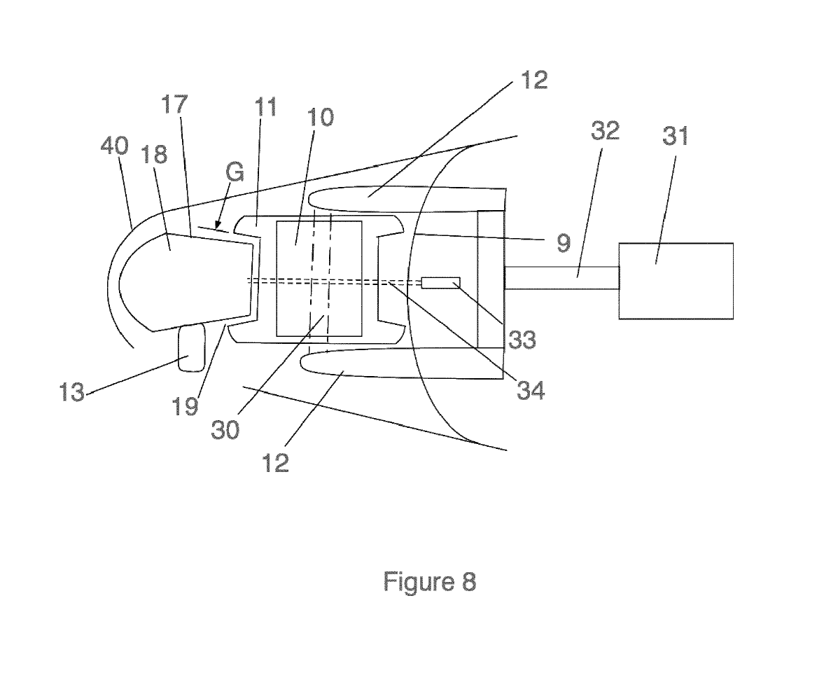

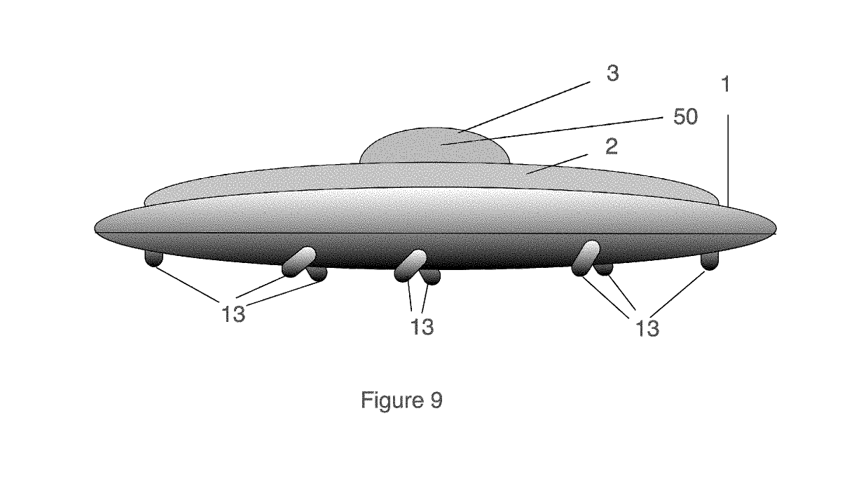

In an alternative embodiment shown in FIGS. 8 and 9, outer ring 18 may also optionally include a series of rotational thrusters 13 which are circumferentially spaced, with corresponding openings formed in the outer housing 40. The thrusters 13 are angled as would be apparent to one of skill in the art.

In this embodiment, the ring 18 is filled with an inert liquid as opposed to fuel, to avoid the diminishing gyroscopic effect of the ring 18 as would occur with the weight reduction from fuel consumption. The ring 18 is operated as in the previous embodiment using bearing assemblies 15 and magnets 4, 5 to lift and stably position the ring 18.

The inner ring 2 provides the primary motive power for lifting and maneuvering the craft 100. The inner ring 2 is non-rotational and is attached directly to the cockpit, extending downwardly therefrom to provide a mounting point for thrusters 7 and magnets 4. The circumferentially spaced articulated downward facing thrusters 7 are provided on the underside of the ring 2 to provide initial lift and primary propulsion for the craft 100. The thrust angle of the thrusters 7 can be varied by servos so as to control both vector and velocity of the craft. Fuel for the thrusters 7 may be contained in a fuel tank, with fuel distribution lines (not shown) feeding the thrusters 7 under microprocessor control from control center 51. The thrusters 7 are connected to the inner ring 2 in an articulated manner so as to provide controllable directional thrust for controlling the craft 100. In addition to articulating down thrusters 7, counter rotational thrusters 6 are provided to rotate the ring 2 relative to the ring 1. By this action, frictional drag created by the rotation of the outer ring 1 can be countered.

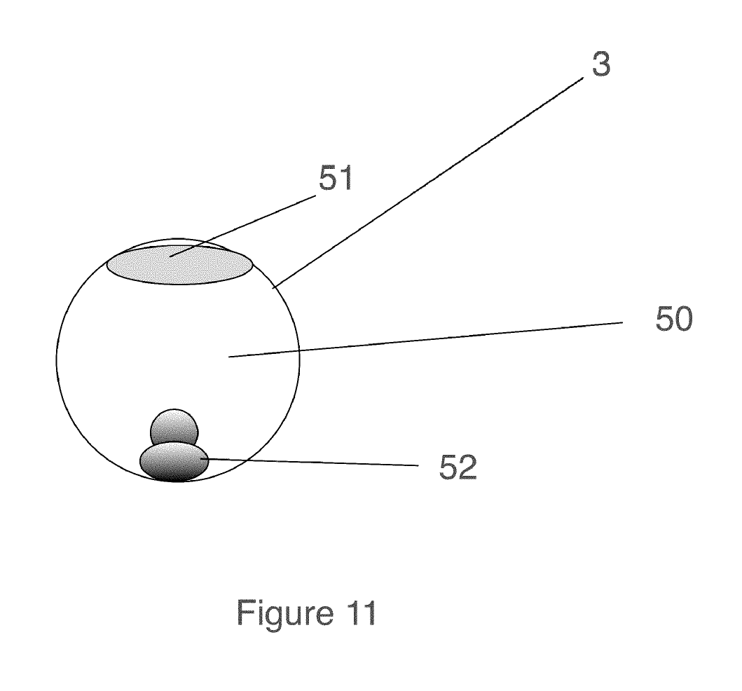

The control center 3 provides a housing for the cockpit 50 and is situated within ring 2, to which it is attached as seen in FIG. 11 and previously discussed. The control center 3 includes the cockpit 50 and various networked control units 51 for controlling inner 2 and outer rings 1. The cockpit 50 also includes environmental controls and other controls and instrumentation as would be apparent to one of skill in the art. Control center 3 includes a transparent dome 53 and cushioned seat 52.

The inner cockpit 50/control center 51 will also be a fully sealed ejection pod to allow escape/rescue in the event of total power failure. The inner cockpit 50/control center 51 will have a parachute for enabling the inner cockpit 50/control center 51 to be ejected and to land safely on land or water. Emergency radio beacon/GPS will be used for location identification. Cushioned seat 52 will aid in minimizing injury.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

I claim:

1. A hovercraft comprising:
a main housing, said main housing containing a cockpit and control center;
an outer ring, said outer ring rotatable supported within said housing and including means for providing motive power thereto;
an inner ring, said inner ring rotatable supported within said housing and including means for providing motive power thereto, said inner ring also including means for providing directional thrust.

2. The hovercraft of claim 1 wherein said outer ring is hollow and includes a quantity of fuel.

3. The hovercraft of claim 1 wherein said outer ring is hollow and includes a quantity of an inert liquid.

4. The hovercraft of claim 2 wherein said ring is provided rotational motive power by a series of thrusters.

5. The hovercraft of claim 4 wherein the fuel stored in the outer ring is fed to said thrusters.

6. The hovercraft of claim 1 wherein said outer ring is rotated by a mag-lev system.

7. The hovercraft of claim 6 wherein said outer ring includes a series of circumferentially spaced permanent magnets.

8. The hovercraft of claim 1 wherein said inner ring has articulatable thrusters for lift and directional motivation and permanently angled rotational thrusters.

9. The hovercraft of claim 1 wherein said outer ring is rotated in a first direction and said inner ring is rotated in a second, opposite direction.

10. The hovercraft of claim 9 wherein angular velocity of said inner ring is adjusted in accordance with the sensed angular velocity of the outer ring.
